(19) United States
(12) Patent Application Publication
(10) Pub. No.: US 2006/0242072 A1
(43) Pub. Date: Oct. 26, 2006

(54) Method and system for creation, management and analysis of distribution syndicates

(75) Inventors: Ariel Peled, Yehuda (IL); Lidrer Troyansky, Givataim (IL); Assaf Litai, Kfar Saba (IL); Ofir Carny, Kochav-Yair (IL); Arik Baratz, Hadera (IL); Guy Roglit, Ramat HaSharon (IL); Hila Avisar, Ramat Gan (IL)

Correspondence Address: G E Ehrlich;Anthony Castorina, Suite 207, 2001 Jefferson Davis Highway, Arlingon, VA, 22202, US

(73) Assignee: Vidius, Inc

(21) Appl. No.: 10/471,605

(22) PCT Filed: Mar. 31, 2002
(86) PCT No.: PCT/IL02/00268

§ 371 Date: Sep. 24, 2003

Related U.S. Application Data
(60) Provisional application No. 60/279,133, filed on Mar. 28, 2001.

(51) Int. Cl. G06Q 99/00

(52) U.S. Cl. 705/51

(57) ABSTRACT

A method of distributing digital content or service over a communication network is provided. The method is effected by: (a) analyzing a request for distribution of the digital content or service; (b) generating a policy associated with the digital content or service; and (c) assembling a distribution syndicate of distribution entities, the distribution entities being selected according to the policy associated with distribution of the digital content or service, the distribution syndicate being for distributing the digital content or service over the communication network.

### FIELD AND BACKGROUND OF THE INVENTION

The present invention relates to electronic commerce of digital content in general, and more particularly to ad hoc dynamic syndication of various entities for the purpose of distributing digital content or service.

One of the pillars of modern economy are distribution chains, where goods undergo various steps during their production, assembly and distribution before reaching the end user. Such distribution chains are designed to allow each participating entity to focus on a certain aspect or step in the chain, thereby allowing development of expertise and niches qualities. Methods of studying and analyzing such distribution chains are routinely utilized in order to enhance the efficiency and profitability of a distribution chain and to eliminate problematic links and bottlenecks.

While a distribution chain provides an adequate metaphor for the distribution of physical products, where the different entities in the chain operate in a sequential mode, the distribution of digital contents is not limited to a sequential mode. Furthermore, the flexibility of electronic commerce allows for dynamic and adaptive creation of ad hoc syndicates, where each member of the syndicate contributes to the value and the quality of the resulting product and/or service, provided that appropriate tools and methods for creation and managements of such syndicates exist. The distribution model in such a syndicate can be described as a “distribution graph” (rather then the traditional “distribution chain”), where each entity is represented as a node, and connections between the entities are represented as edges in the graph.

In the current state of affairs, the wide horizon of promising opportunities described above is not fully exploited. One of the reasons for this is that the prior art did not characterize a useful model for ad hoc, dynamical syndication for distribution of digital contents, which facilitate cooperation of the various entities in order the maximize the total utility of the transactions. Ad hoc syndication may be susceptible to non-cooperative behavior, best described by the “prisoner dilemma” model in the context of game theory. In addition, potential participants in such a syndicate usually come from diverse backgrounds and do not share a common language that would allow rapid exchange of information which is required for the formation, management and analysis of the “distribution graphs” and “distribution chains” of digital contents.

There is thus, a recognized need for, and it would be highly advantageous to have, a method and system for creation, management and analysis of distribution graphs and distribution chains.

### SUMMARY OF THE INVENTION

According to one aspect of the present invention there is provided a method of generating a distribution syndicate for distributing digital content or service over a communication network, the method comprising: (a) analyzing a request for distribution of the digital content or service; (b) generating a policy associated with distribution of the digital content or service; (c) using the policy to select at least one syndicate candidate from a plurality of syndication candidates; and (d) forming the distribution syndicate from the at least one syndication candidate, the distribution syndicate being for distributing digital content or service over the communication network.

According to further features in preferred embodiments of the invention described below, step (c) is effected by analyzing a response to the policy from each of the plurality of syndication candidates.

According to another aspect of the present invention there is provided a method of distributing digital content or service over a communication network, the method comprising: (a) analyzing a request for distribution of the digital content or service; (b) generating a policy associated with the digital content or service; and (c) assembling a distribution syndicate of distribution entities each being capable of communicating with the communication network, the distribution entities being selected according to the policy associated with distribution of the digital content or service, the distribution syndicate being for distributing the digital content or service over the communication network.

According to still another aspect of the present invention there is provided a method of generating a distribution syndicate for distributing digital content or service over a communication network, the method comprising: (a) analyzing a request for distribution of the digital content or service; (b) selecting a plurality of syndication candidates being capable of communicating with the communication network; and (c) generating a policy associated with distribution of the digital content or service according to information retrieved from each of the plurality of syndication candidates; (d) using the policy to select at least one syndicate candidate from the plurality of syndication candidates thereby forming the distribution syndicate.

According to an additional aspect of the present invention there is provided a method of distributing digital content or services over a communication network, the method comprising: (a) analyzing a request for distribution of the digital content or service; (b) determining a set of services necessary to distribute the digital content or services over the communication network; (c) formulating a distribution policy according to the set of services; and (d) assembling a distribution syndicate of distribution entities each being capable of communicating with the communication network, the distribution entities being selected according to the distribution policy, the distribution syndicate being for distributing the digital content or service over the communication network.

According to still further features in the described preferred embodiments the policy includes details of a proposed distribution scheme of the digital content or service.

According to still further features in the described preferred embodiments the policy includes details of conditions for participating in the distribution syndicate.

According to still further features in the described preferred embodiments the conditions include compensation.

According to still further features in the described preferred embodiments the compensation is selected from the group consisting of monetary compensation, resource compensation and service compensation.

According to still further features in the described preferred embodiments the policy is generated according to at least one parameter associated with the digital content or service.

According to still further features in the described preferred embodiments the at least one parameter is selected from the group consisting of value of the digital content or service, security requirements, mode of distribution, methods of distribution, quality of the digital content or service, advertisements distributed with the digital content or service, financing requirements, insurance requirements.

According to still further features in the described preferred embodiments the insurance requirements comprise insurance against unauthorized secondary distribution of the digital content or service.

According to still further features in the described preferred embodiments the policy is generated according to at least one parameter pertaining to a requirement of an end user of the digital content or service.

According to still further features in the described preferred embodiments the digital content includes data selected from the group consisting of textual data, video data, audio data, and application data.

According to still further features in the described preferred embodiments the plurality of syndication candidates include at least one content provider being for distributing the digital content.

According to still further features in the described preferred embodiments the plurality of syndication candidates include at least one content right holder or licenser capable of licensing the digital content or service for distribution.

According to still further features in the described preferred embodiments the plurality of syndication candidates include at least one money collector capable of performing monetary transactions related to the distribution of digital content or service over the communication network.

According to still further features in the described preferred embodiments the at least one money collector is capable of collecting funds from end user of the digital content and/or transfer money to the plurality of syndication candidates.

According to still further features in the described preferred embodiments the funds are provided via credit or debit card debiting, electronic money or bank transfers.

According to still further features in the described preferred embodiments the plurality of syndication candidates include at least one insurance agent capable of insuring the distribution syndicate against distribution failures.

According to still further features in the described preferred embodiments the request for distribution of the digital content or service is provided by an end user of the digital content or service.

According to still further features in the described preferred embodiments the request for distribution of the digital content or service is provided by a provider of the digital content or service.

According to still further features in the described preferred embodiments step (a)-(c) or (d) are effected by a central management unit capable of communicating with the plurality of syndication candidates.

According to still further features in the described preferred embodiments the digital service includes computational services.

According to still further features in the described preferred embodiments the communication network is a computer network.

According to still further features in the described preferred embodiments the communication network is a cellular network.

According to still further features in the described preferred embodiments the plurality of syndication candidates include at least one entity selected from the group consisting of a bandwidth provider, a service provider, an advertiser, an advertisement provider a content or services reseller, financial service provider and a security service provider.

According to still further features in the described preferred embodiments the security service provider is capable of providing at least one service selected from the group consisting of watermarking, data encryption, authentication, geo-location, certification, encryption key management and digital rights management.

According to still further features in the described preferred embodiments at least two of the syndication candidates are operated by a single entity.

According to yet an additional aspect of the present invention there is provided a system for distributing digital content or services over a communication network comprising a computerized central management unit designed and configured for: (a) analyzing a request for distribution of the digital content or service; (b) generating a policy associated with the digital content or service; and (c) assembling a distribution syndicate of distribution entities, the distribution entities being selected according to the policy associated with distribution of the digital content or service, the distribution syndicate being for distributing the digital content or service over the communication network.

According to still further features in the described preferred embodiments the computerized central management unit is further designed and configured for negotiating with a plurality of distribution entity candidates prior to assembling the distribution syndicate of distribution entities.

According to still further features in the described preferred embodiments each of the plurality of the distribution entity candidates and the computerized central management unit operates a processing module designed and configured for enabling the negotiations between the computerized central management unit and each of the plurality of the distribution entity candidates.

According to still further features in the described preferred embodiments the processing module is an artificial intelligence module.

According to still further features in the described preferred embodiments the negotiations are used to select the distribution entities.

According to still further features in the described preferred embodiments the distribution entities are selected from the group consisting of content providers, content distributors, content rights holders, resellers of the content, money collection services, investors, legal services providers, financial services providers, insurance companies, content distribution networks (CDN), network service providers, advertisers, bandwidth providers, and security providers.

According to still further features in the described preferred embodiments the distribution entities include at least one content server being capable of transferring digital content to an end user.

According to still further features in the described preferred embodiments the content server is capable of streaming the digital content to the end user.

According to still further features in the described preferred embodiments the digital content is interactive digital content.

According to still further features in the described preferred embodiments the content server is further capable of interacting the end user.

According to still further features in the described preferred embodiments the interacting provides the end user control over the transferring of the digital content.

According to still further features in the described preferred embodiments the control is effected by an action selected from the group consisting of stopping the transferring of the digital content, pausing the transferring of the digital content, changing the speed of the transferring of the digital content and selecting specific data from the digital content.

According to still further features in the described preferred embodiments the computerized central management unit utilizes predetermined rules to assemble the distribution syndicate.

According to still further features in the described preferred embodiments the computerized central management unit rewards cooperative behavior by the distribution entity candidates.

According to still further features in the described preferred embodiments the computerized central management utilizes a cooperative algorithm for selecting the distribution syndicate.

According to still further features in the described preferred embodiments the cooperative algorithm includes a decentralized management protocol

According to still further features in the described preferred embodiments the computerized central management utilizes distributed uniform calculation of a pre-determined algorithm for selecting the distribution syndicate.

According to an additional aspect of the present invention there is provided a system for distributing digital content or services over a communication network comprising a computerized central management unit designed and configured for: (a) analyzing a request for distribution of the digital content or service; and (b) selecting distribution entity candidates being capable of inter-communicating over the communication network, wherein at least one of the distribution entity candidates is designed and configured for: (i) generating a policy associated with the digital content or service; and (ii) assembling a distribution syndicate of distribution entities from the distribution entity candidates according to the policy associated with distribution of the digital content or service, the distribution syndicate being for distributing the digital content or service over the communication network.

According to still further features in the described preferred embodiments the computerized central management unit is further designed and configured for negotiating with a plurality of distribution entity candidates prior to selecting the distribution entity candidates.

According to still further features in the described preferred embodiments each of the plurality of the distribution entity candidates and the computerized central management unit operates a processing module designed and configured for enabling negotiations between the computerized central management unit and each of the plurality of the distribution entity candidates.

According to still further features in the described preferred embodiments the processing module is an artificial intelligence module.

According to still further features in the described preferred embodiments the distribution entity candidates are selected from the group consisting of content providers, content distributors, content rights holders, resellers of the content, money collection services, investors, legal services providers, financial services providers, insurance companies, content distribution networks (CDN), network service providers, advertisers, bandwidth providers, and security providers.

According to yet an additional aspect of the present invention there is provided a method of gathering information relating to a distribution syndicate for distributing digital content or service over a communication network, the distribution syndicate being formed ad hoc from syndication entity candidates according to a request for distribution of digital data or service, the method comprising monitoring at least some of the syndication entity candidates prior to or following assembly of the distribution syndicate and collecting data pertaining to the formation and/or operation of the distribution syndicate.

According to still further features in the described preferred embodiments the data includes information relating to the request for distribution of digital data or service.

According to still further features in the described preferred embodiments the data includes information relating to policies governing formation of the distribution syndicate.

According to still further features in the described preferred embodiments the data includes information relating to the efficiency and/or quality of operation of the distribution syndicate.

According to still further features in the described preferred embodiments the data includes information relating to operational costs of the distribution syndicate.

According to still further features in the described preferred embodiments the data includes information relating to security of the distribution syndicate.

According to still further features in the described preferred embodiments the data includes information relating to operational failures within the distribution syndicate.

According to still further features in the described preferred embodiments the data includes information relating to an end user of the digital content or service.

According to still further features in the described preferred embodiments the information relating to an end user of the digital content or service includes habits of the end user and/or preferences of the end user.

According to still further features in the described preferred embodiments collecting data pertaining to the formation and/or operation of the distribution syndicate is effected by a computerized central management unit designed and configured for forming the distribution syndicate.

According to still further features in the described preferred embodiments collecting data pertaining to the formation and/or operation of the distribution syndicate is effected by a participant of the distribution syndicate.

According to still further features in the described preferred embodiments collecting data pertaining to the formation and/or operation of the distribution syndicate is effected by at least one of the syndication entity candidates.

According to still further features in the described preferred embodiments the data is providable to at least some of the syndication entity candidates.

According to still further features in the described preferred embodiments the data is utilized for selecting syndication entities from the syndication entity candidates.

According to still further features in the described preferred embodiments the data is statistically processed by the computerized central management unit.

According to still further features in the described preferred embodiments the statistically processed data is stored in a database.

According to still further features in the described preferred embodiments the database is a decentralized database.

The present invention successfully addresses the shortcomings of the presently known configurations by providing a method and system for creation, management and analysis of distribution syndicates for efficiently conducting transactions in the field of digital content distribution.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a is a simplified conceptual illustration of a distribution graph for digital content, created and managed by a central management entity, constructed and operative in accordance with one preferred embodiment of the present invention;

FIG. 2 is a simplified flowchart illustrating operation of the system of FIG. 1;

FIG. 3 illustrates an embodiment of the system of the present invention which employs a centralized management unit composed of a heterogeneous network of computers;

FIG. 4 illustrates an embodiment of the system of the present invention which employs a centralized money collection service;

FIG. 5 illustrates a decentralized distribution graph for digital content, constructed and operative in accordance with a preferred embodiment of the present invention;

FIG. 6 illustrates a system for data analysis and report distribution, constructed and operative in accordance with a preferred embodiment of the present invention;

FIG. 7 is a screenshot of a graphical user interface (GUI) utilizable by a content provider in order to initiate a distribution process;

FIG. 8 illustrates a configuration of the system depicted in FIG. 1 which includes additional entities;

FIGS. 9a-i illustrate the process of launching new video content by a content provider using a graphical user interface of a system constructed in accordance with the teachings of the present invention; and

FIGS. 10a-c illustrate rule generation using a graphical user interface of a system constructed in accordance with the teachings of the present invention.

### DESCRIPTION OF THE PREFERRED EMBODIMENTS

The present invention is of a method and a system for creation, management and analysis of ad hoc syndicates and distribution graphs. The invention can be used, in particular, for distribution of digital content while utilizing flexible business models.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Efficient and cost effective commercial digital data distribution relies upon several factors including coordination of the various entities which participate in the creation, distribution and consumption of commercially available digital data.

To date, distribution of products such as digital content relied upon content distribution networks (e.g., distribution chains) of predefined architecture. Although such distribution networks enable an end user to request and retrieve digital data, the predefined architecture thereof limits the efficiency, cost effectiveness and scope of digital data distribution.

In sharp contrast to prior art systems and methods, the present invention provides a system and method which enable automatic creation and management of ad hoc, dynamic, syndicates for the purpose of commercial distribution of digital content such as, for example, video, audio, application software and/or game files.

Thus, while prior art methods of distributing digital content are typically configured as “distribution chains”, wherein the various entities in the “chain” operate in a sequential mode in order to distribute the product and/or to add value to it, the distribution of content in the framework of the present invention is best described as a “distribution graph” (e.g., a web or mesh), where the various entities are represented by the vertexes (nodes) of the graph, and connections between the entities are represented by the edges (arches) of the graph.

The distribution graph itself can be created dynamically, in order to provide ad-hoc syndication of various entities or services.

Such a distribution graph is created using participants communicating over a communication network, such as, a computer network (e.g., the World Wide Web) or a telephony network (e.g., cellular network).

Participants of a distribution graph may include entities such as content providers, content distributors, content rights holders, resellers of the content, money collection services, investors, legal services providers (lawyers, advocates, legal counselors, etc.), financial services providers, insurance companies, content distribution networks (CDN), network service providers [e.g., Internet Service Providers (ISPs)], advertisers, commercial advertisement agencies, advertising agencies that promote selling of the content, and content servers that provide the content to the end user. The content may be protected by a digital rights management mechanism (DRM) or other security mechanism designed to mitigate unauthorized tampering, copying or distribution. The DRM mechanism may require or use supporting services (e.g. auditing, secure interfaces, encryption, certification, key management, etc.) from specialized entities and/or from other entities involved in the transaction.

The syndicate can be initiated and managed by a centralized entity that manages the communication from the various entities and forms an optimized syndication by incorporating into the syndicate the most appropriate candidates, or by forming a syndicate that is the best compromise of the needs, wills and constrains of the entities involved. Constraints which may be taken into account may be legal (e.g., anti-trust regulations), contractual, technological, commercial and the like.

Alternatively, no central entity is involved in the creation, enforcement of the policy and coordination of decision making in a syndicate, wherein a syndicate is created and managed in a distributed manner, preferably using common software clients (protocols) in each of the entities that facilitate communication and enforcement of the syndicate policy.

It will be appreciated that both of the above described architectures can be synergistically exploited, wherein some degree of collaboration between the entities is assisted by a central unit and the remaining collaboration is achieved through distributed or unilateral decision making software protocols.

In any case, efficient communication and information exchange between the various entities in a syndicate according to the present invention requires that the various entities reliably communicate with one another.

In order to achieve this requirement, the entities of a syndicate preferably utilize a common language (a business language), such as extensible mark-up language (XML) which utilizes a common dictionary.

Alternatively, a syndicate can utilize several such languages. This can be achieved by: (i) ensuring that any pair of service-performing entities that communicate, share such a language (e.g., a language for content servers and content distribution networks to communicate with each other); (ii) providing a mediating entity which is operable to translate the languages used by the various entities; or (ii) channeling the plurality of possible communication routes through a collaborative entity (e.g., an intermediate entity) which shares a common language with each of the entities of the syndicate. This is especially useful when several entities that essentially provide the same service, do not utilize the same language, thus requiring the entities communicating with them to support a number of different languages.

Preferably the candidate participants in the syndicate are equipped with a software and/or hardware engine that creates messages in a uniform format. The bodies of the messages contain at least some of the relevant information that would allow the central manger and/or other participants and/or potential participants to estimate the potential merit of incorporating the candidate or themselves into the syndicate

Candidates participants are also preferably equipped with a software and/or hardware engine that allows the central manager and/or the participants to define policies and strategies and to estimate potential revenues in various scenarios. The evaluation of the scenarios might include not only the evaluation of revenues, but also of risks, especially security risk, which will provide the means to decide whether to require the use of a certain security policy or risk reducing scheme, such as encryption or authentication service or an insurance agency.

Other parameters which are of importance to the distribution of digital data according to the present invention such as market development or advertising, are also considered. Some parameters, e.g., risks level or market development potential may be hard to predict because of uncertainty factors, in which case an uncertainty decision scheme, such as using heuristics for prediction and to provide certainty assessment are involved, the uncertainty assessment might also be taken into account when making a decision, thereby allowing participants to build pricing schemes and distribution policies and to bid a price for participation. Bidding from a single node of the distribution graph may involve a single policy or service type offering (such as an authentication scheme) or multiple policy/service type-price pairs.

In a preferred embodiment of the present invention the engine include a graphical user interface (GUI) for policy determination, parameter insertion and display, etc.

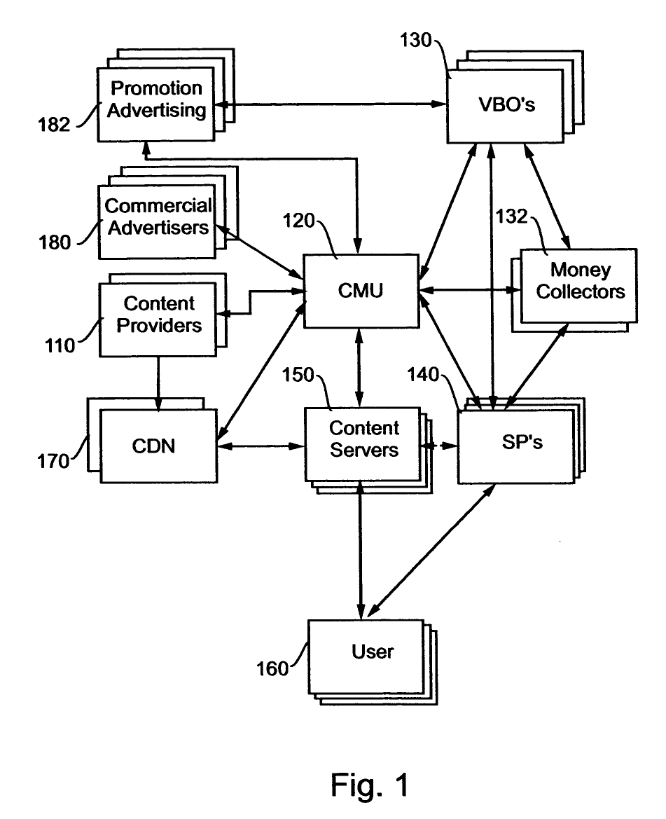

Referring now to the drawings, FIGS. 1-8 illustrate the system and method of the present invention in more detail.

FIG. 1 schematically illustrates a distribution-graph system which is referred to hereinafter as system 100. The configuration of system 100 which is illustrated in FIG. 1 is controlled and managed by a centralized management unit (CMU).

System 100 includes content providers 110 which provide distributable content (e.g., a video file) to centralized management unit (CMU) 120. The content may thereafter be registered and subjected to pre-processing, which preferably include extraction of a characteristic “signature” as well as pre-processing that may facilitate efficient embedding of (preferably) personalized watermarking in subsequent stages. Preferably, content provider 110 also provides a policy, or a set of rules, that reflect its preferences, distribution strategy, limitations, pricing schemes etc. In some syndication models resellers or “virtual box offices” (VBO) 130 participate as graph entities, thereby promoting the efficiency of the distribution.

VBOs 130 can use external money collectors 132 which can use the information residing in CMU 120 in order to enhance the authentication level and/or to obtain a better estimate of the user credibility (of any participant in the graph), thereby reducing or assessing chances of fraud. Content distribution networks (CDNs) 170, which provide efficient distribution of content by employing distributed networks of proxy servers (e.g., using the “Akamai” method, described in U.S. Pat. No. 6,108,703), can also participate in some syndicates; proxy servers of CDNs 170 can provide efficient caching of commonly requested content, thereby effectively reducing the required bandwidth needed for distribution.

The use of CDNs 170 within the distribution graph depends on various parameters, such as the frequency in which the content is required, the content size, other existing bottlenecks, etc.

System 100 also includes content servers 150 which are capable of providing digital content to the end users. The content can be provided in streaming and/or download modes. In one embodiment of the present invention, the content servers are directly controlled by CMU 120. In a preferred embodiment of the present invention, the content servers provide contents with personalized watermarks (steganograms) and/or encryption. Efficient schemes for generating on-line personalized steganograms are described in US patent application U.S. patent application Ser. No. 09/772,538, filed Nov. 28, 2000 and in PCT IL01/00923 filed Oct. 3, 2001.

Watermarking of distributed digital content provides numerous benefits to a distribution scheme. It enables correlation between the content and the end user to which it was issued by embedding the information in the watermark, or by storing (in a database) information operable to correlate such information to the information stored in the watermark. In addition, watermarking can also be used to correlate between data and every entity that had access to it during the distribution by embedding several independent watermarks within the data distributed.

Thus, when a personalized content copy that was illegitimately distributed (e.g. leaked or pirated) is intercepted, it is possible to discern the identity of the likely perpetrator, thereby deterring potential offenders from pirating data.

Several considerations are taken into account by CMU 120 when deciding what security measures should be employed in a specific distribution transaction.

For example, watermarking may be required when high value content is distributed since the expected monetary damage incurred by piracy in such a case can be relatively high.

Thus, when deciding what security measures are applied, CMU 120 takes into account policies of the various nodes (entities), by using, for example, a policy sharing/coordination system. Note that in cases, where collaboration agreements are confidential, the system of the present invention preserves policies and agreements as confidential information either by using a zero knowledge system, queries, or a central protected decision system.

System 100 can also employ service providers (SP) 140 which can serve as money collectors, as authentication authorities, as host for content servers, as providers of network bandwidth under various pricing schemes etc.

Commercial advertising is an important source of revenues in various multimedia distribution models. Such advertising can be incorporated into the multimedia content either prior to, or during, distribution.

CMU 120 can negotiate with commercial advertisers 180 about incorporation of advertisements. CMU 120 can use known methods to target key demographic information and to use statistical information in order to customize the advertisements according to the final user profile, thereby increasing the effectiveness of the advertising. Usage of such information may also be priced or restricted according to some privacy requirements, which might also be controlled by the system.

Selling of multimedia content can be promoted using promotion advertising 182. The promotion can be incorporated into the site of the reseller (e.g., VBO 130). Promotion strategies and policies can be formulated according to information gathered by CMU 120. For example, if numerous end users that bought content “A” also bought content “B”, (i.e., there is a positive correlation between purchases of the two contents), then content “B” can be suggested to other end users of content “A”.

Edit of promotion clips (“promos”) can also be assisted by such information: e.g., the promo edit for costumers of content “A” can focus on the characteristics that are common to both content “A” and content “B”.

It will be appreciated that the system of the present invention can also include additional entities which are selected according to considerations such as, the content to be distributed, the need of the consumer and other entities and the like.

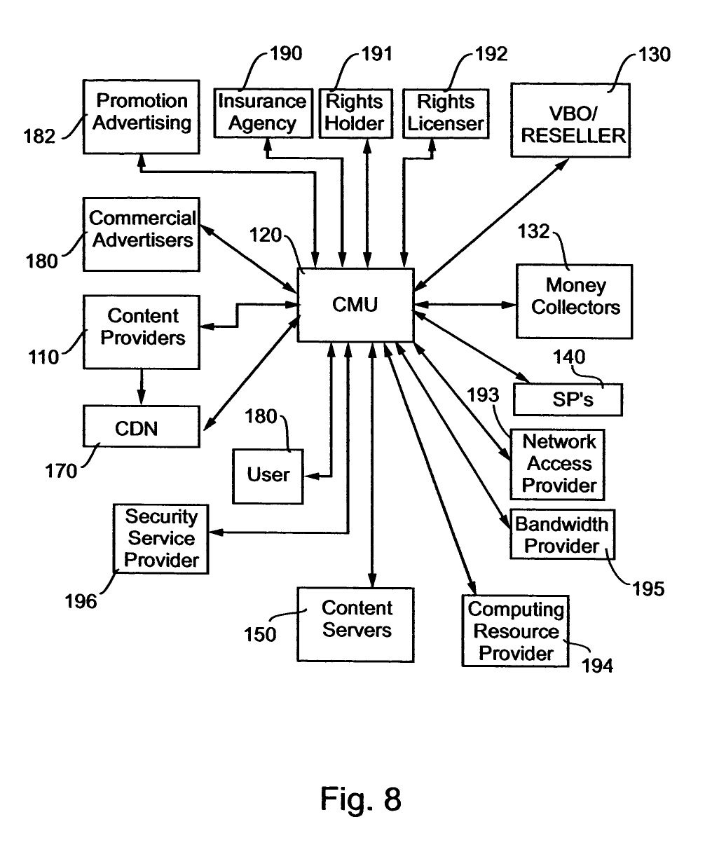

For example, and as is illustrated in FIG. 8, the system of the present invention may also include entities such as an insurance agency 190, content right holders 191, content right licenser 192, network access provider 193, computing resource provider 194, network bandwidth provider 195 and security service provider 196.

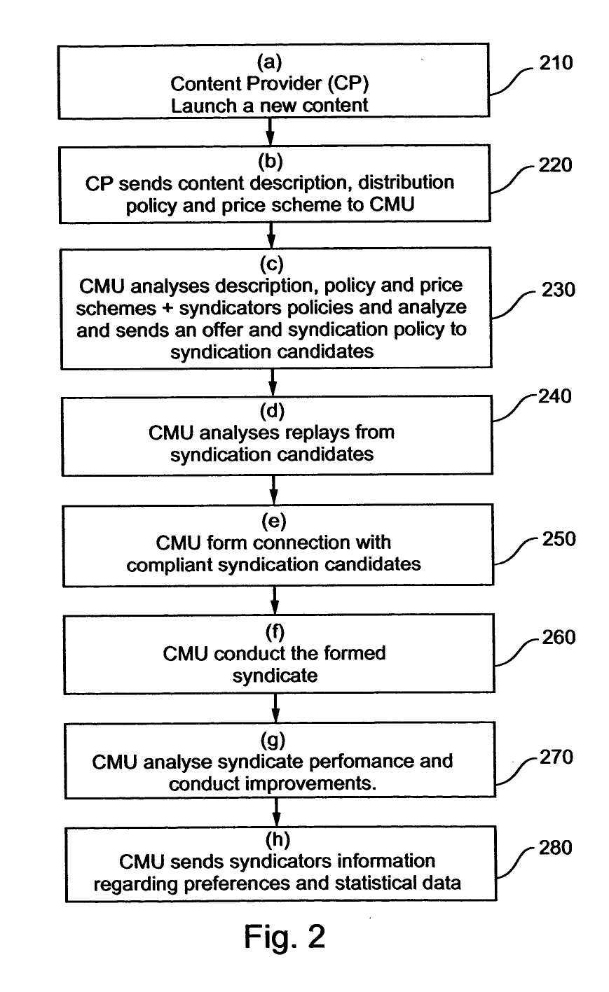

FIG. 2 illustrates the dynamics governing ad hoc generation of a syndication scheme according to the present invention. As illustrated therein, once a content provider launches a new content (stage A, indicated by 210), the content description, distribution policy and price scheme are thereafter sent to CMU 120 (stage B, indicated by 220). It should be noted that an initiative for distribution can also come from any type of participant or candidate, and not only from content providers/recipient.

As shown in stage C (indicated by 230) CMU 120 analyzes the description, policy and price scheme associated with the content, and locates candidates for syndication (Resellers (VBO), advertisers, content distribution networks, Internet service providers, money collectors etc). CMU 120 preferably analyzes their policies or response to the policy associated with the content and either sends an offer to suitable candidates, or a request for proposals (RFP). RFPs can be provided by advertisers bidding for advertising spots in distributed content, content distribution networks can propose cashing services and/or certain number of proxy servers in a certain distributaries together with the appropriate price-scheme, or resellers can be requested to bid proposals for selling the content at their sites.

Once CMU 120 analyzes the replies (stage C, indicated by 230) it forms connections with selected syndication candidates (stage E, indicated by 250), to thereby construct an ad hoc distribution syndicate conforming to a distribution graph. Once the distribution syndicate is constructed it is operated by CMU 120 (stage F, as indicated by 260).

As the distribution process evolves, CMU 120 analyzes the performance of the “distribution graph” and conducts improvements, if needed. Such improvements may include better promotion, discarding of inefficient entities/participants, or evaluating new syndicate candidates (stage G, as indicated by 270). In addition, CMU 120 may provide entities of the syndicate with valuable information regarding user preferences and other statistical data that is accumulated as the process continues. Such data can be used to improve the process or to allow syndicate entities to improve their performance (stage H, as indicated by 280).

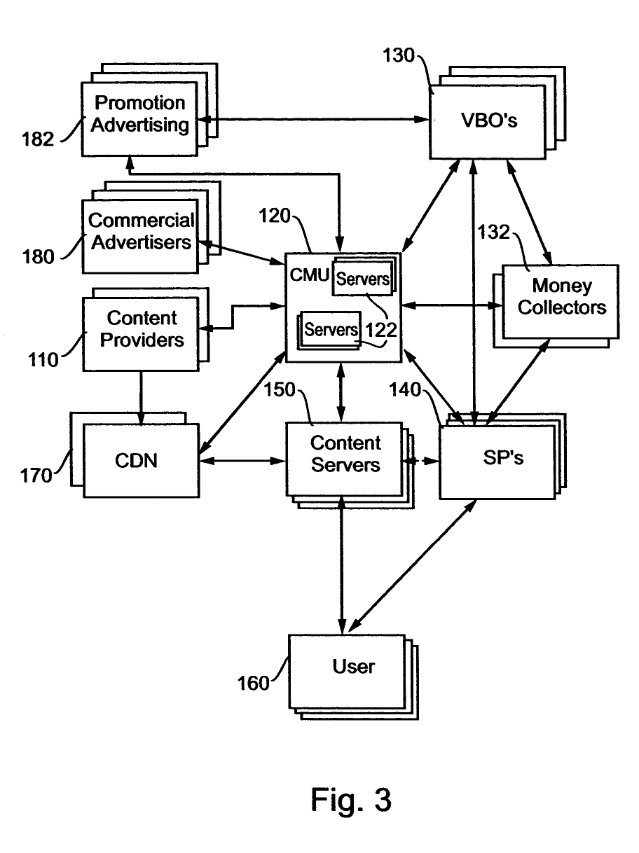

It will be appreciated that CMU 120 does not have to be a single computer or server. FIG. 3 illustrates a system which is similar to the system of FIG. 1, but in which CMU 120 is composed of a heterogeneous network of computers/servers 122. Such a configuration allows more flexibility in resource allocation. In addition, it also allows compartmentalization of data thereby enhancing data protection.

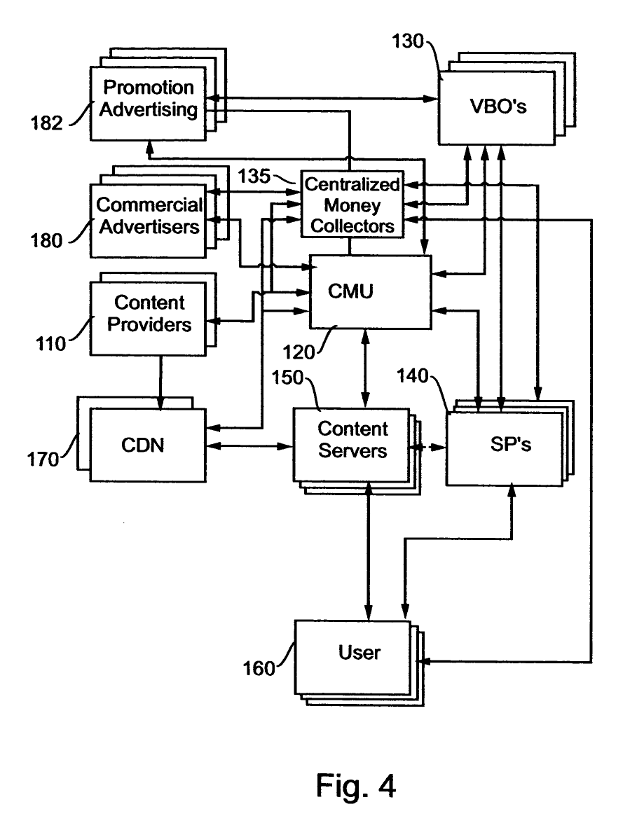

FIG. 4 illustrates a system which is similar to the system of FIG. 1, but which utilizes a centralized money collection service 135. According to this configuration, funds are collected from entities such as resellers 130, advertisers 180, ISP 140 and end-users 306, and is paid to entities such as content providers 110, promoters 182 and content distribution networks 170.

Although centralized management of the distribution syndicate is advantageous, the distribution graph of the present invention can also be constructed without a central management unit by employing several cooperating business entities.

Such a distribution scheme can be designed to induce cooperation, to reward cooperative, reliable or trustworthy participants, to induce market growth, to provide consumer choice and to enhance efficiency and utilization. In a decentralized architecture, it is conceivable that various decisions will be made through negotiation between the entities.

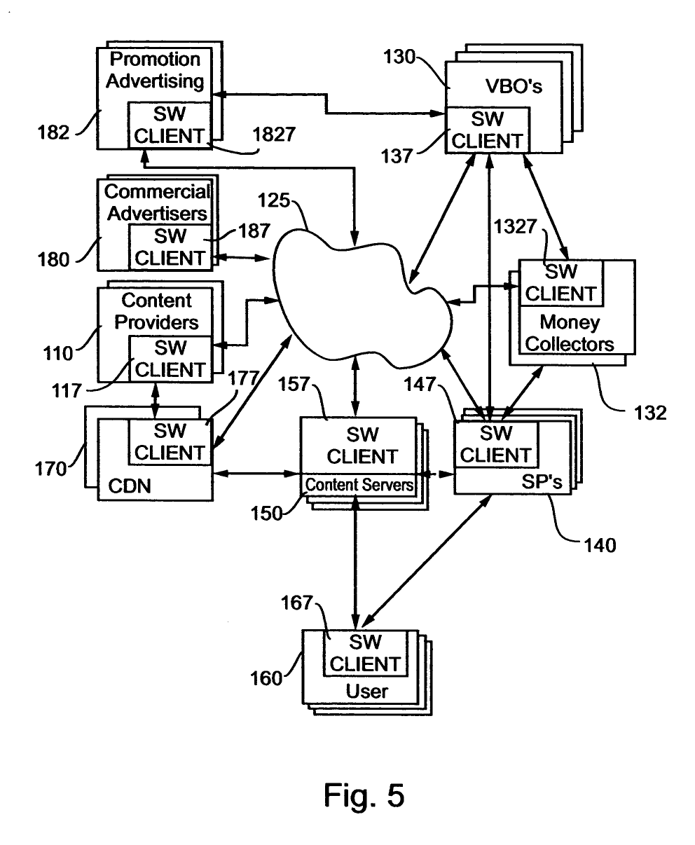

FIG. 5 illustrates a system which is similar to the system of FIG. 1, but which does not employ a centralized management entity. In such a configuration, various syndicate candidates inter-communicate using a communication network 125 such as, for example, the Internet.

Each of the syndicate candidates is equipped with a corresponding software client that enable decentralized formation and operation of the ad hoc syndicate. For example, content provider 110 is equipped with software client 117, virtual box office 130 is equipped with software client 137, money collector 132 is equipped with software client 1327, service provider (SP) 140 is equipped with software client 147, content server 150 is equipped with software client 157, user 160 is equipped with software client 167, content distribution network 170 is equipped with software client 177, commercial advertiser 180 is equipped with software client 187 and promotion advertising agency 182 is equipped with software client 1827.

These software clients contain software modules that use algorithms that facilitate the formation of an efficient syndicate. In general, each of the syndicate candidates may be greedy, while efficient syndication requires that all the syndicate members will act in a cooperative manner. There are several known methods for the cooperation of several greedy entities without a trusted coordinator.

According to a preferred embodiment of the present invention, the decision-making is performed by the interaction of artificial intelligence (AI) agents which represent the participants [references 1-4] Although it is conceivable that these AI agents may be instructed to operate greedily rather than to cooperate, the negotiation arena is preferably designed to induce cooperation (e.g. using a bidding scheme which rewards the least selfish and most efficient participant in the transaction). Such an AI agent may actually be controlled to some degree by the participants, or preferably exist as a set of rules supplied by the participant in the decision making mechanism and designed to simulate their behavior. In the latter case, cooperation may be enhanced by restricting the possible rules or by adding rules designed to induce or favor cooperation. In some cases rules are place to introduce non-negotiable constraints (e.g., due to legal or other external constraints or a due to a requirement on behalf of the content provider for a watermark protection for its content).

The following illustrates a scheme which can be used to model cooperative bidding.

A simple algorithm is used by the participants to select a random number in a manner that ensures that the participants know that it is random.

Random number selection is effected as follows:

(i) each of the participants chooses a random number;

(ii) each of the participants generates two cryptographic keys;

(iii) each of the participants uses the first key to sign the random number;

(iv) each of the participants uses the second key to encrypt the random number;

(v) each of the participants sends the signed and encrypted number and the signature key to all the other participants, preferably using secure communication;

(vi) participants acknowledge receipt of all values;

(vii) after all acknowledges are received by the participants, each of the participants sends the encryption key to all other participants;

(viii) all the participants use all the encryption keys to decrypt all the random numbers; and

(ix) all the participants use all the signature keys to verify the decrypted random numbers.

The function is used on all the random numbers uniformly by all participants, and the result is the agreed upon random number.

This algorithm assumes that no participant is attempting to sabotage the result, in case that a sabotage attempt is found (e.g. by verifying the resulting numbers and by using a timeout to ensure that responses arrive in a timely fashion), all trustworthy participants report the offender and ignore it for the rest of the operation.

To save time, several random numbers are selected simultaneously.

A simple algorithm is used by syndicate candidates (participants) to issue bids in a manner that ensures that all participant know that no participant issued a bid based on knowledge of other bids.

The algorithm is effected as follows:

(i) each of the participants chooses a bidding offer;

(ii) each of the participants generates two cryptographic keys;

(iii) each of the participants uses the first key to sign the bidding offer it has chosen;

(iv) each of the participants uses the second key to encrypt the bidding offer it has chosen;

(v) each of the participants sends the signed and encrypted bidding offer and the signature key to all the other participants. Preferably using secure communication;

(vi) participants acknowledge receipt of all values;

(vii) after all acknowledges are received by the participants, each of the participants sends the encryption key to all other participants;

(viii) all the participants use all the encryption keys to decrypt all the bidding offers;

(ix) all the participants use all the signature keys to verify the decrypted random numbers; and

(x) a wining bid is selected uniformly by all participants.

Similarly, this algorithm also assumes that no participant is attempting to sabotage the result. In the case that a sabotage attempt is found (e.g. by verifying the resulting numbers and by using a timeout to ensure that responses arrive in a timely fashion), all trustworthy participants report the offender and ignore it for the rest of the operation.

Although the above described bidding is decentralized it can be coordinated by one of the participants which assumes some of the functions of the CMU in order to coordinate and to manage the syndicate. Some members of the syndicate may employ and/or coordinate secondary service providers as subcontractors, in order to promote efficiency or reduce costs. This process may further result in several layers of services (e.g. secondary services, tertiary services, quaternary services etc.).

According to a preferred embodiment of the present invention, trusted or semi-trusted bid modules (software application for executing the bid selection algorithm) are utilized by participants in a manner that ensures that the operational distribution syndicate is selected fairly.

The algorithm utilized for bid selection is publicly agreed upon and is carried uniformly by several or preferably all participants or candidates in the selection process (such that fraud is readily revealed). This algorithm can utilize the method for bidding and selecting random numbers described above. The bid modules selected are preferably resistant to pirating copying, thus ensuring that each participant utilizes a participant-specific module. For example, the modules can use cryptographic methods to ensure that module tampering is difficult to effect and/or detectable.

According to a preferred embodiment of the present invention, the decision-making process described hereinabove is capable of simulating or modeling the possible outcomes of the decisions and the behavior of the AI agent (when employed). Preferably, past outcomes are taken into account and correlated to the expected outcomes in order to improve the simulation or model (this practice is commonly referred to as artificial learning).

Similarly, the decision-making process may employ artificial learning functionality, thereby improving decision-making based on past data.

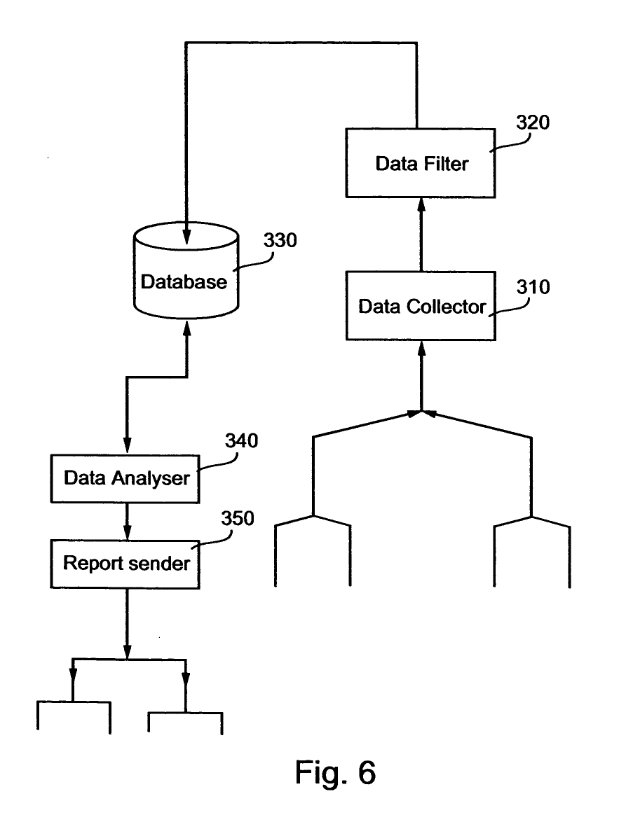

FIG. 6 is illustrates a system for data analysis and report distribution which can be utilized by the present invention.

A data collector 310 collects relevant data from the consumers and the various entities in the syndicate. A data filter 320 removes irrelevant and/or redundant data and stores the relevant data in database 330. A data analyzer 340 analyzes the data in database 330 (e.g., using standard querying and artificial learning methods) and produces reports which are then sent by report sender 350 to the relevant recipients.

Data collected may include information on participant's willingness to cooperate, participant's trustworthiness, participant's technical reliability (i.e. its past ability to perform its undertaking without technical problems such as overload or malfunctions), unexpected costs (including usage and load of resources), service's technical reliability, entity's technical reliability, consumer behavior, participant behavior and preferences, market behavior and preferences, etc.

The decision-making process can be designed to perform decisions on a per transaction basis, or on the basis of a class of transactions. In some cases, the decision-making process may also classify the transaction.

The decision-making process is preferably designed to reduce use of resources. For example, the decision-making process may reapply past decisions (according, for example, to past outcomes) thereby reducing computation requirements.

The information gathered by the decision making process may be stored and/or provided to participants following processing, provided such information is free of legal restrictions.

Since the distribution syndicate relies on participant confidentiality, the present invention preferably identifies each participant by using a temporary ID number which changes with each new transaction. Such a scheme decreases the likelihood that a participant is unwantedly identified by another participant.

These practices may help to insure the privacy of consumers and prevent fraud.

Management of such a diverse distribution graph, with entities of various types, backgrounds, interests etc. requires the formation of a basic setup that allows effective communication and evaluation of the situations, strategies and policies.

Thus, according to one preferred embodiment of the present invention, CMU 120 provides syndicate candidates software and/or hardware packages that (preferably) support their decisions and represent their replies in a common language, thereby allowing effective cooperation between the various parties in the ad hoc syndicate.

The packages would allow each of the syndication candidates and/or participants to analyze the implication of taking a certain policy in a certain ad hoc syndicate. The analysis may encompass the properties of each of the other participants in the distribution graph, on a per event basis, in order to determine entity's behavior (e.g., content usage, viewing patterns, buying patterns, content search patterns, promotion consumption patterns, ad consumption patterns), consumer behavior (as individuals or groups), resources invested in distribution (e.g., money, promotions and other resources invested) and revenue generated. Such information can be provided per se or as a function of consumer profiles and the distribution graph properties.

The information can be gathered by according to demographics and/or statistics, recurring events, behavioral patterns recognition and analysis, what-if modeling, correlation and regression estimation, and/or marketing information collection.

Analysis of information may employ general multivariate statistical methods (cross-correlations, co-variance, principle component analysis etc.), as well as methods for artificial learning, such as artificial neural networks, [references 5-7], Bayesian networks [reference 8] and Support Vector Machines [reference 9]. Missing and noisy features can be compensated using the marginal statistics over the missing/noisy feature and/or set by user intuition.

Participants and/or candidates can be allowed to use some of the information gathered by CMU 120 to optimize the participation decision.

The degree of information available to the participant or candidate usually depends on several parameters such as the level of security, level of authenticity, the interests of the other participants or candidates and the like.

One method which can be employed to manage the information and execute decisions based both on the information and the policy, is to group information on the distribution graph participants and candidates under different categories, and to base the decisions on the degree of association of participants and/or candidates to specific groups. For example, if consumer Sam Smith belongs to the ‘bought three movies last year’ group, the reseller belongs to the ‘sells above $10 M a year’ and the content belongs to the ‘Western’ genre, then approve the transaction and let the price be $2.20.

Thus, the policy pertaining to specific content may also be structured according to rule language statements, such as, conditional statements, queries, branches, actions, comparisons, arithmetic functions, properties, group membership and others.

The decision execution based on the gathered information and pre-defined policy may be done by a rule language analyzer, such as a compiler and/or interpreter, or other.

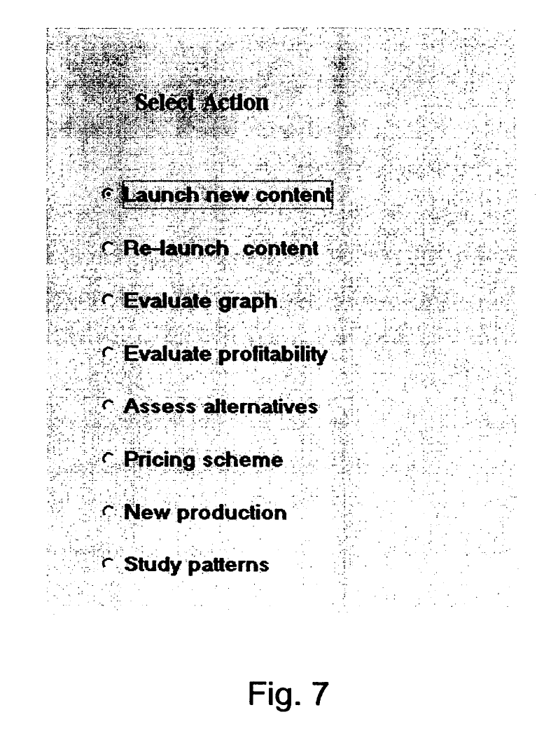

FIG. 7 illustrates a screen shot of a graphical user interface (GUI), which can be used by a content provider. Such a GUI enables the content provide to:

Launch new content: initiates a decision support system that allows the content provider to provide a succinct description of the content

Re-launch content: allowing the user quicker launching, while using information accumulated during a previous launching.

Evaluate graphs of distribution for any type of content: a function which exposes potential candidates to syndication (e.g., resellers, advertisers, promoters, other content providers etc.) and an optimized distribution graph. Evaluation may be effected using business rules, artificial intelligence, expert systems, statistical analysis, computational analysis and manual inputs.

Evaluate profitability from any member of the distribution graph (syndicate): the content provider can estimate the expected profits from the members of the distribution graph: e.g., from selling spots for commercial ads and/or from commissions from re-sellers. Estimation of the expected profits from selling spots for commercial ads can be based on classical models for selling spots and/or on models for selling ads spots for well-targeted audience.

Assess possible alternatives for contracts with resellers, service providers, content distribution networks, Internet service providers, money collectors, advertising agencies/companies and any other participant in the distribution graph: this function allow the content provider to run distribution scenarios with various participants. The information gathered by the system can be used to find the most effective distribution channels (resellers, SPs) according to consumer coverage, estimated revenue and other parameters.

Build pricing schemes: allows the user to build a price scheme according to pre-defined business rules, suggestions from expert system, statistical information, “what if” scenarios, content's details similarities to known contents and the like.

Plan new data production: this option supports user decisions regarding new productions of movies (selection of actors, directors, budget etc.) based on statistical data, consumers profile etc.

Study the behavioral patterns of consumers: this function allows the user to statistically analyze user behavior and reaction to distributed content, reaction to promotion advertising of various kinds, to pricing schemes and the like.

A similar user interface can be employed by re-sellers in order to support decisions making regarding reseller actions. Such a GUI would enable the reseller to: choose content providers and advertisers to work with, choose new contents from lists, supplied by content providers, build pricing schemes (possibly within the limitations dictated by content providers), build a content portfolio (i.e., the total “stock” of content that can be provided by the resellers), build “content packages”, i.e., combining several contents into a package that will be sold in a price that is lower then the combined price of its components, assess current policies, evaluate profitability from other members of the distribution graph (e.g., advertisers), and/or perform data mining to study consumer behavioral patterns.

A GUI employed by advertisers can include the following functions: choosing partners (e.g., content providers, virtual box offices and service providers), add new advertisements, build pricing schemes, assess current policies, and/or studying consumer behavioral patterns.

The advertisements can be characterized by features such as: ad length, ad actors, ad producer, ad production year, ad views, ad price, ad producing agency, advertised brand (e.g., “Gap”, “AOL”, “Kellogg's”, “Thomas Cook”, etc.), ad nature (kids, clothing, airlines, food, adult, etc.), and/or ad rating (adult ads for adult features). Cross referencing such ad categories with information associated with a specific content distribution can be used to match advertisement with a particular distribution syndicate.

Advertisements for promotion of the distributed content (“promos”) can also be selected using decision support system. Some of the parameters that may be considered are: content genre and promo genre, promo type, promo rating and/or promo length.

The system of the present invention can also be configured for automatic creation of clubs grouping specific consumer profiles thereby justifying price differentiation.

In order to support the decision making, such as price differentiation for various types of consumers, or legal restrictions according to age groups, the consumers, as well as other syndicate candidates and members may be grouped according to a distinguishing property or a number of such properties (a consumer or a syndicate candidate/member may belong to more than one group).

In such cases, a decision taken can be filtered through a rule based decision mechanism which is aware of entity mapping (grouping) and possibly other properties and information and contains the rules dictated by the various rule dictating entities.

To facilitate decision making, the system of the present invention preferably utilizes a “rule engine”. Such a rule engine employs a software and/or hardware implemented parser for interpreting a “language” (described below). Such a parser can be implemented as a compiler, an interpreter, or as a pre-compiler—interpreter combination.

The language interpreted by the parser is comprised of units called rules. A rule is a basic unit of the language. A rule can be checked by the parser, and as a result, the parser may perform an action, several actions or check additional rules—as determined by that rule.

Thus, the language can be described as a set of rules, which may or may not be ordered in a single or multiple levels, and may contain other attributes associated with them.

Example 3 of the Examples section which follows illustrates a rule based language which can be used by the present invention.

There is no limit to the number of rules the parser can examine, nor is there an importance to the method of expressing such rules. The set of rules may be expressed in written statements or in other forms, including a graphic representation of the rule in a graphical user interface.

The parser may perform an action in response to a single rule or a set of rules. In some instances, the parser may require additional data to interpret a single rule.

Data required by the parser for rule processing can include information about the consumer which requests the viewing, buying, streaming, download or other rights of a content, information on the content itself, information on the reseller wishing to sell the viewing, buying, streaming, download or other rights of such content to the consumer, information on the delivery network (CDN) that is to deliver the content to the SP for storage, and information on the SP that stores the content.

Additional information that may be required includes credit/debit issues, consumer authenticity (credentials), the sum in question and advertising related information.

Information relating to the syndicate candidates may be needed for an advertising event, which may mean that a commercial/promotional content is streamed, downloaded, multicasted, broadcasted or delivered by other means to a consumer.

Other data that may be required by the parser includes information about the current time and date, and other temporal and environmental information (example of which can be the holidays pertaining to the consumer's location, etc.).

Information relating to the entities may be supplied by the entities themselves, by other entities, mined from data gathered by control and auditing systems and by other means. Additional information may be gathered by the parser while processing the rule.

Data gathered may be represented by values, vectors, or by classification into groups and categories.

Thus, a rule is similar to a control statement of a programming language. The rule has a number of conditional expressions exp1.expn and a number of action lists, act1.actm. When the rule is checked, the parser evaluates some or all of the conditional expressions, and executes none, one or more of the action lists (by executing all the actions in that list), in accordance with the evaluated values of some or all of the evaluated expressions.

An example of a rule is an “if—then—else” rule, such as: if exp1 then act1 else act2. When encountering this type of rule, the parser acts upon the actions in act1 when exp1 evaluates as true and act2 when exp1 evaluates as false.

Expressions may also include actions. Each action list can contain, as one of its actions, a new rule. If that specific action gets executed, the parser evaluates the rule and (possibly) executes its actions, and then return to complete the execution of the current rule. In such cases, the rule is referred to as being “nested” inside another rule.

An action is the “executable” part of the rule. An action in a rule may be executed, depending on the evaluation of the rule, and once “executed”, the parser may change an external state or value, may call inside or outside function, change an internal state that may affect further executions of actions, or all.

When affecting the external state of the parser, the action will be used, either exclusively or combined with other means, to determine the availability of the content to the consumer, determine the price the consumer has to pay for the viewing of the content, create a change in group membership of the consumer, CP, VBO, SP and/or advertiser, determine the number of advertisement the consumer views, change a consumer property, and any other such operation that can be performed on the data that is used by the system.

Although the system of the present invention is described hereinabove in context of distribution of digital data, it will be appreciated that such a system and syndication scheme can also be used to perform tasks other than distribution of digital content. For example, the system of the present invention can generate ad-hoc syndicates for providing services. Such services can include computation services, storage services, offline services (e.g. managing an offline physical transaction or service), application services (e.g. renting or using a software application), communication services (e.g. video conferences, information relay), online games, multiplayer games, online multiplayer games, data sharing, computing and network resource sharing, and the like.

For example, syndication participants can includes vendors that supplies CPU (central processing unit) resources, data storage (e.g., disk-space), utility software and network bandwidth. The syndicate that provides the resources can be initiated by one of the vendors or by a user that needs the combined resources, in a manner similar to that described above for content distribution syndicates.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Example 1

### Launching New Content

To launch new content, a content provider performs a sequence of steps and decisions which may be assisted by a decision-support application which can be supplied by the central management unit described hereinabove. Such an application preferably includes an easy to use graphic user interface (GUI) thus greatly facilitating the decision making process.

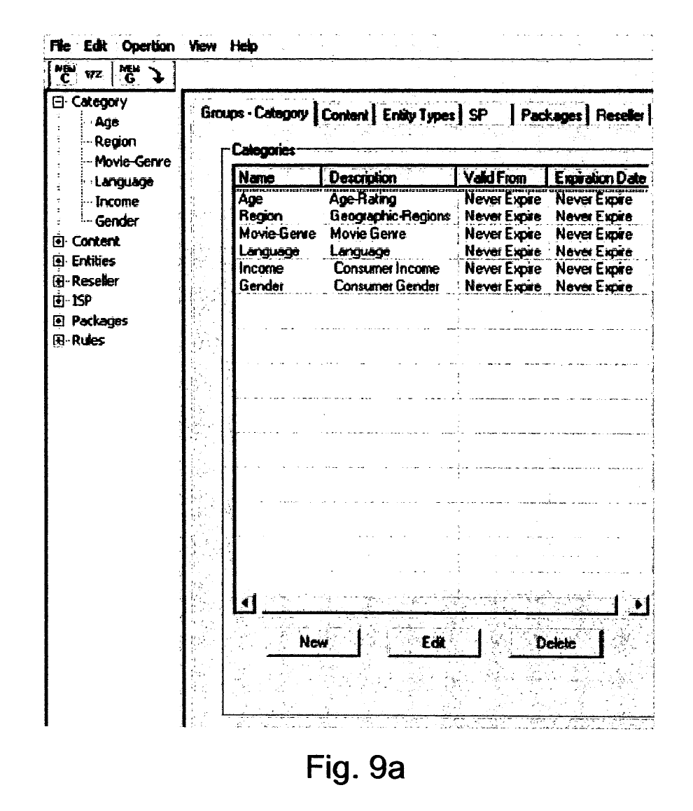

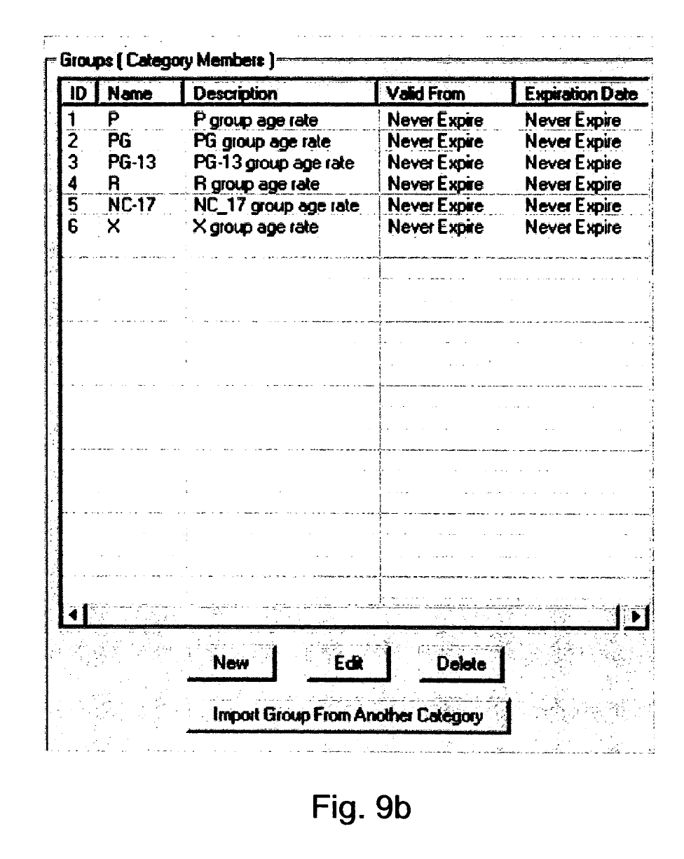

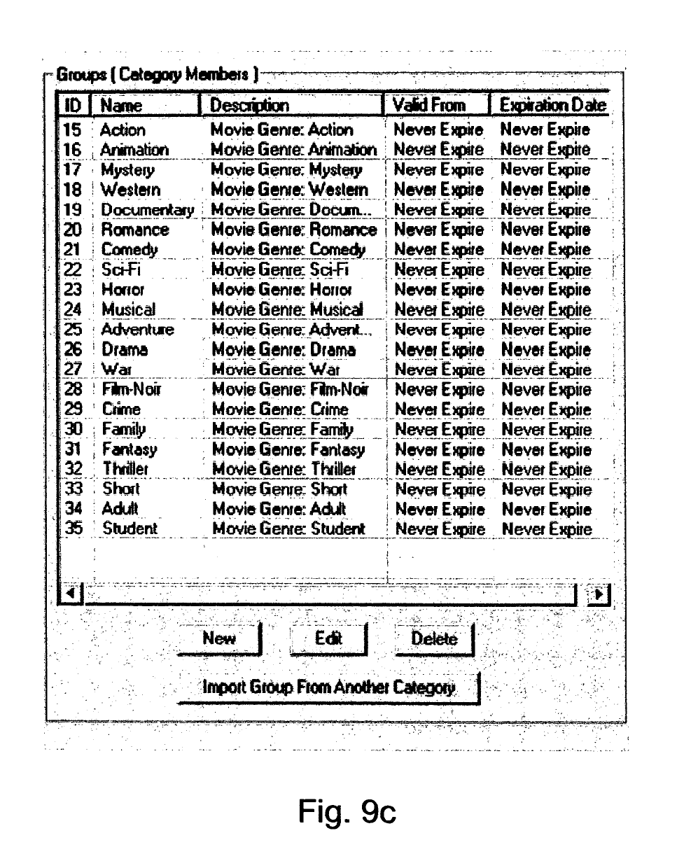

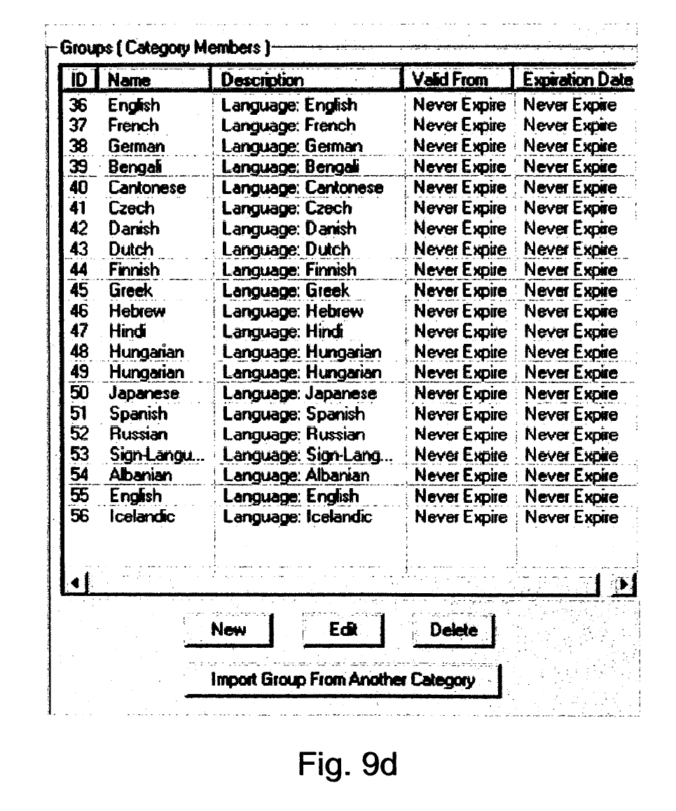

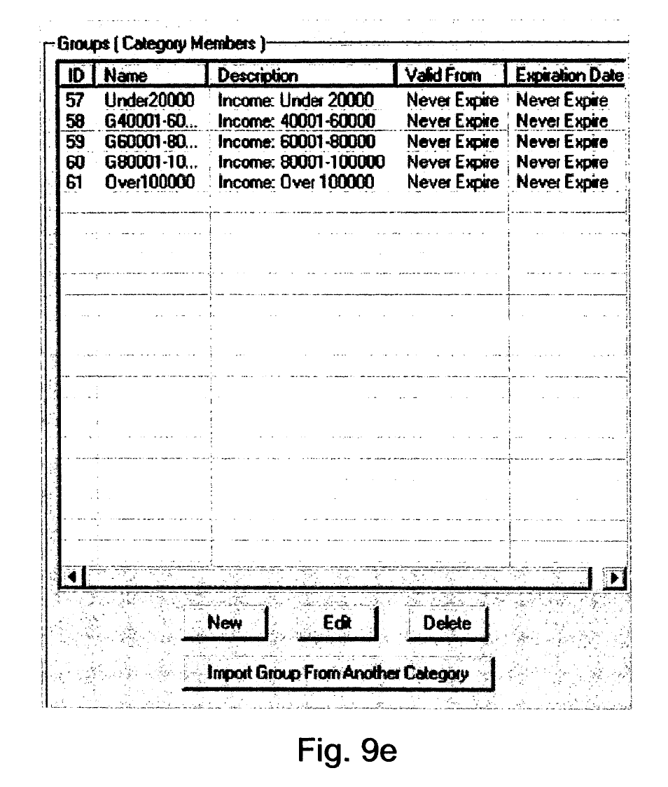

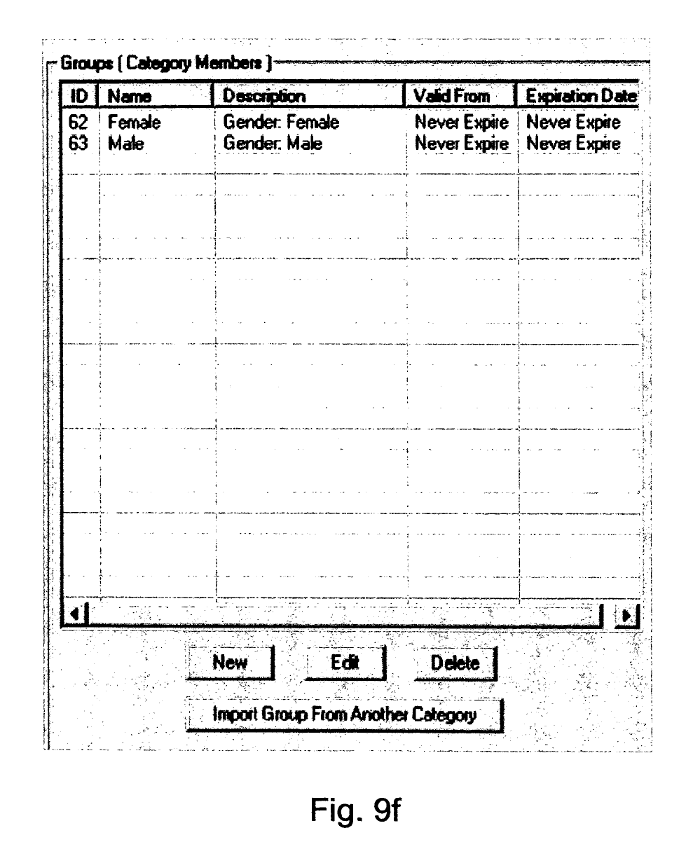

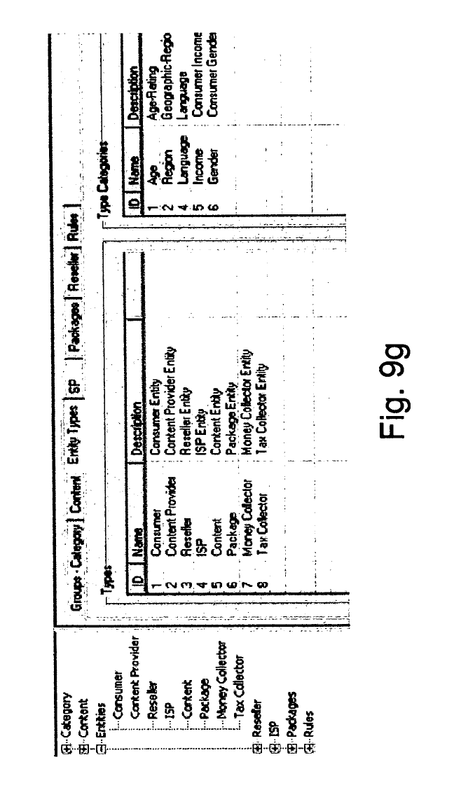

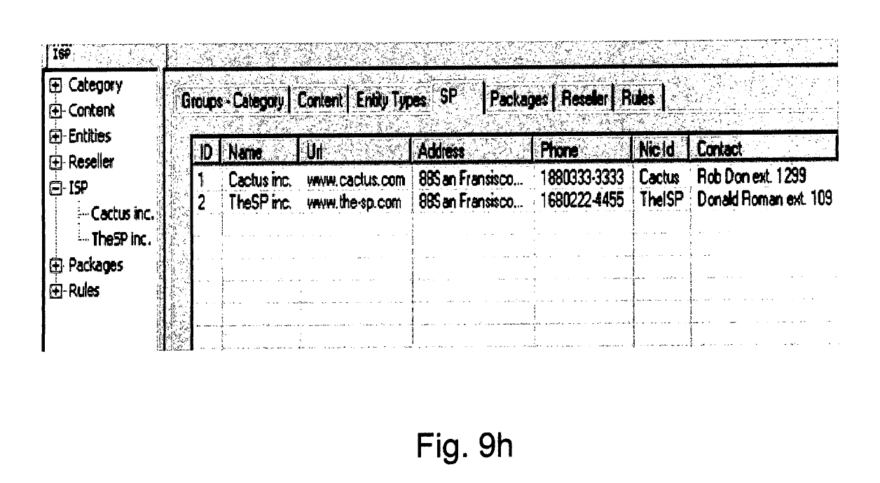

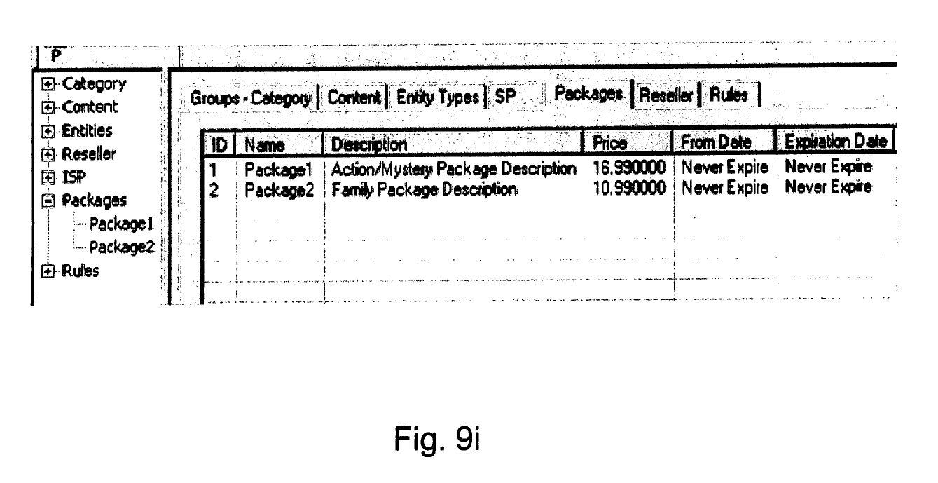

As is illustrated in the GUI screenshots of FIG. 9a-i. The process of launching new content begins with selecting basic criteria group (FIG. 9a) which is effected by the following steps: (i) inserting group age rate (FIG. 9b); (ii) inserting the movie genre (FIG. 9c); (iii) inserting content language (FIG. 9d) and other content characteristics such as type: (long movies, trailers, promos, short movies) rating (user rating, MOAA rating), academy award (“Oscar”) winnings, newspaper reviews, consumer reviews, revenue generated, cost of production, cost of distribution, cost of maintenance, return on investment (ROI), director, actors, producers, studio, year of production, language, length, sound quality, screen type (wide/standard), color/black & white, bit-rate, edition, genre, target age group and country of origin; (iv) inserting the desired consumer's income (FIG. 9e), (v) inserting the desired consumer's gender and any other consumer characteristics (FIG. 9f).

Following selection of the criteria group the process continues with analysis and selection of syndication candidate/members (FIG. 9g) including selection of an ISP (FIG. 9h). The process then concludes with selection of content packages (FIG. 9i).

### Example 2

### Defining Rules According to General Criteria Using a “Rule Builder” Graphical User Interface

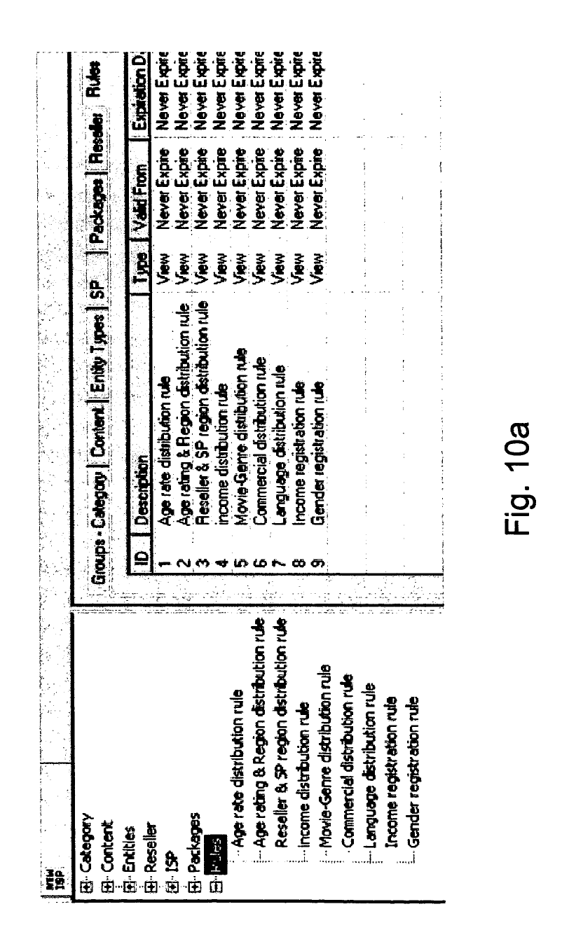

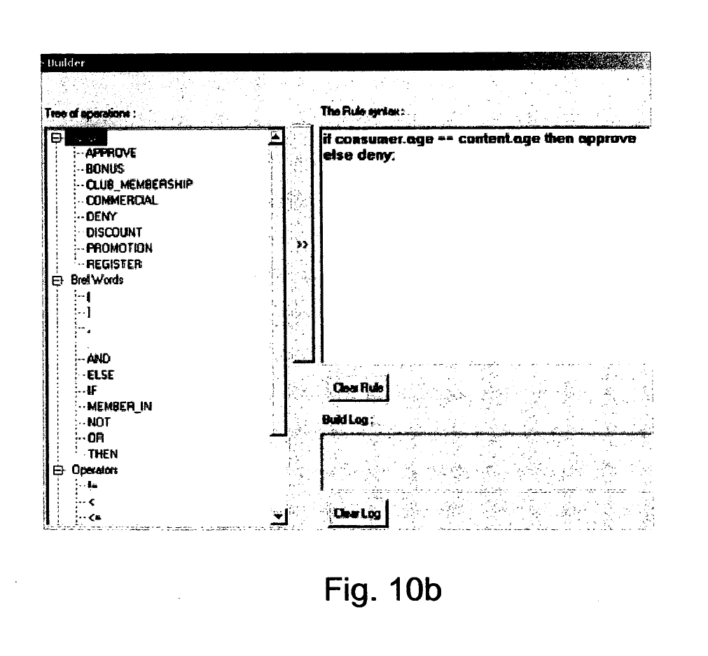

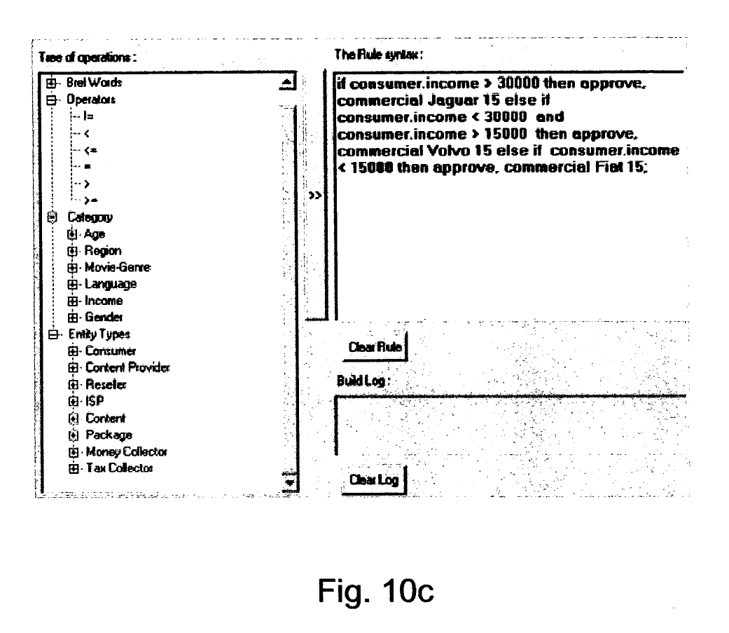

FIGS. 10a-c illustrate the process of defining rules according to the present invention. The process involves selection of rule type (FIG. 10a) and constructing a new rule (FIG. 10b). FIG. 10c illustrates construction of a rule regarding commercial advertisement.

### Example 3

### Usage of Business Rules—Considerations Taken by a Content Provider when Launching a New Video Content

The following describe an action sequence for new content ‘wrapping’ i.e., promotion, price, target market (geographic & demographic):

Add New Content:

“Mrs. Doubtfire”

Enter the Content Characteristics:

Category: ‘Comedy’

Run Time: ‘125 minutes’

Film rating: ‘PG’

Video Format: ‘MPEG 4’

Screen Size: Wide Screen

File size: ‘500 MB’

Audio quality: ‘Dolby Surround’

Director: ‘Chris Columbus

Actors: Robin Williams, Sally Field, Pierce Brosnan

Decide on the Test Market According to Existing Data in the System:

Target audience—calculate optimal age: the average age of audiences watching PG comedies is 19.5; optimal age group is 18-25

Calculate region for distribution—the two best places for comedies will be:

Wisconsin—19,563 comedy features purchased per month during 1999

Philadelphia—18,976 comedy features purchased per month during 1999

Choose Web Promoters for Placing Banners at for the New Release Within Wisconsin and Philadelphia:

youth.com has a target audience of 18-25 with 2.5M hits per month

chat.com has a target audience of 18-25 with 2.2M hits per month out of which 400 K come from Philadelphia and Wisconsin.

gap.com has a target audience of 18-25 with 1.9M hits per month

Choose Non-Web Promoters:

Friday night Comedy shows at Starlight theatres enjoy 95% of the audience to be at the age group of 18-25

NBC ‘Friends’ on weeknights primetime has ratings of 12.33%

Pricing Content:

New released Comedies are priced at an average of $4.50. Factors that will determine pricing include season of launch, the actors, the producer, the director, the studio, profitability at the theatres and is the movie classified as ‘classic’

Choose Advertisers to Enter Their Ads into the Content:

75% of Fanta's target audience is age group 18-25.

83% of Gap's sales are to age group 18-25.

Choose Promotions:

On Gap's site, give $5 discount coupon for the next purchase at Gap to anyone buying Mrs. Doubt Fire during the next month.

Offer coupon of $1 off a 6 pack of Fanta on your next purchase at Wal-Mart.

Examine Costs of Distribution:

CDN:

To Wisconsin: Akamai for traffic up to 150 GB per week: $19.95 per GB; Cidera for any larger quantities at $21.50 per GB.

To Philadelphia: Digital Island for traffic up to 100 GB per week: $15.50 per GB; Cidera for any larger quantities at $18.85 per GB.

SP:

In Wisconsin: AT&T host each 100 GB at $5.50 per 1 GB; AOL host each 100 GB at $5.95 per 1 GB

In Philadelphia: Excite@home host each 100 GB at $5.750 per 1 GB; AOL host each 100 GB at $5.99 per 1 GB

ROI:

Build several what-if scenarios to calculate alternate ROIs and choose the best.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the present invention.

### REFERENCES

1. Crowston, Kevin; Malone, Thomas W (1988): Intelligent Software Agents. Byte (December), 267-71.
2. Cimatt, Alessandro; Serafini, Luciano (1995): Multi-Agent Reasoning with Belief Contexts: the Approach and a Case Study. In: Intelligent Agents. (Eds: Wolldridge, Michael; Jennings, Nicholas R) Springer-Verlag, Berlin, 71-85.
3. Sardine: An Agent-facilitated Airline Ticket Bidding System, Software Demos, Proceedings of the Fourth International Conference on Autonomous Agents (Agents 2000), Barcelona, Catalonia, Spain, June 3-Jun. 7, 2000. (Eds: Joan Morris, Pattie Maes).
4. Kasbah: An Agent Marketplace for Buying and Selling Goods, Proceedings of the First International Conference on the Practical Application of Intelligent Agents and Multi-Agent Technology, London, UK, April 1996. (Eds: Anthony Chavez, Pattie Maes)
5. Haykin, S.; Neural Networks: A Comprehensive Foundation, Prentice Hall, 1998.
6. Bishop, C. M.: Neural Networks for Pattern Recognition, Oxford University Press, (1995).
7. Fausett, L. V.: Fundamentals of Neural Networks, Prentice Hall, (1994)
8. Jensen, F. V., Jensen, F. B: Bayesian Networks and Decision Graphs (Statistics for Engineering and Information Science), Springer Verlag, (2001).
9. Cristianini, N. and Shawe-Taylor, J.: An Introduction to Support Vector Machines and Other Kernel-Based Learning Methods, Cambridge University Press, (2000).

What is claimed is:

1. A method of generating a distribution syndicate for distributing digital content or service over a communication network, the method comprising:
(a) analyzing a request for distribution of the digital content or service;
(b) generating a policy associated with distribution of the digital content or service;
(c) using said policy to select at least one syndicate candidate from a plurality of syndication candidates; and
(d) forming the distribution syndicate from said at least one syndication candidate, the distribution syndicate being for distributing digital content or service over the communication network.

2. The method of claim 1, wherein step (c) is effected by analyzing a response to said policy from each of said plurality of syndication candidates.

3. The method of claim 1, wherein said policy includes details of a proposed distribution scheme of the digital content or service.

4. The method of claim 1, wherein said policy includes details of conditions for participating in said distribution syndicate.

5. The method of claim 4, wherein said conditions include compensation.

6. The method of claim 5, wherein said compensation is selected from the group consisting of monetary compensation, resource compensation and service compensation.

7. The method of claim 1, wherein said policy is generated according to at least one parameter associated with the digital content or service.

8. The method of claim 7, wherein said at least one parameter is selected from the group consisting of value of the digital content or service, security requirements, mode of distribution, methods of distribution, quality of the digital content or service, advertisements distributed with the digital content or service, financing requirements, insurance requirements.

9. The method of claim 8, wherein said insurance requirements comprise insurance against unauthorized secondary distribution of the digital content or service.

10. The method of claim 1, wherein said policy is generated according to at least one parameter pertaining to a requirement of an end user of the digital content or service.

11. The method of claim 1, wherein the digital content includes data selected from the group consisting of textual data, video data, audio data, and application data.

12. The method of claim 1, wherein said plurality of syndication candidates include at least one content provider being for distributing the digital content.

13. The method of claim 1, wherein said plurality of syndication candidates include at least one content right holder or licenser capable of licensing the digital content or service for distribution.

14. The method of claim 1, wherein said plurality of syndication candidates include at least one money collector capable of performing monetary transactions related to the distribution of digital content or service over the communication network.

15. The method of claim 14, wherein said at least one money collector is capable of collecting funds from end user of the digital content and/or transfer money to said plurality of syndication candidates.

16. The method of claim 15, wherein said funds are provided via credit or debit card debiting, electronic money or bank transfers.

17. The method of claim 1, wherein said plurality of syndication candidates include at least one insurance agent capable of insuring said distribution syndicate against distribution failures.

18. The method of claim 1, wherein said request for distribution of the digital content or service is provided by an end user of the digital content or service.

19. The method of claim 1, wherein said request for distribution of the digital content or service is provided by a provider of the digital content or service.

20. The method of claim 1, wherein step (a)-(d) are effected by a central management unit capable of communicating with said plurality of syndication candidates.

21. The method of claim 1, wherein the digital service includes computational services.

22. The method of claim 1, wherein the communication network is a computer network.

23. The method of claim 1, wherein the communication network is a cellular network.

24. The method of claim 1, wherein said plurality of syndication candidates include at least one entity selected from the group consisting of a bandwidth provider, a service provider, an advertiser, an advertisement provider a content or services reseller, financial service provider and a security service provider.

25. The method of claim 24, wherein said security service provider is capable of providing at least one service selected from the group consisting of watermarking, data encryption, authentication, geo-location, certification, encryption key management and digital rights management.

26. The method of claim 1, wherein at least two of said syndication candidates are operated by a single entity.

27. A method of distributing digital content or service over a communication network, the method comprising:
(a) analyzing a request for distribution of the digital content or service;
(b) generating a policy associated with the digital content or service; and
(c) assembling a distribution syndicate of distribution entities each being capable of communicating with the communication network, said distribution entities being selected according to said policy associated with distribution of the digital content or service, said distribution syndicate being for distributing the digital content or service over the communication network.

28. The method of claim 27, wherein said policy includes details of a proposed distribution scheme of the digital content or service

29. The method of claim 27, wherein said policy includes details of conditions for participating in said distribution syndicate.

30. The method of claim 29, wherein said conditions include compensation.

31. The method of claim 30, wherein said compensation is selected from the group consisting of monetary compensation, resource compensation and service compensation.

32. The method of claim 27, wherein said policy is generated according to at least one parameter associated with the digital content or service.

33. The method of claim 32, wherein said at least one parameter is selected from the group consisting of value of the digital content or service, security requirements, mode of distribution, methods of distribution, quality of the digital content or service, advertisements distributed with the digital content or service, financing requirements, insurance requirements.

34. The method of claim 33, wherein said insurance requirements comprise insurance against unauthorized secondary distribution of the digital content or service.

35. The method of claim 27, wherein said policy is generated according to at least one parameter pertaining to a requirement of an end user of the digital content or service.

36. The method of claim 27, wherein the digital content includes data selected from the group consisting of textual data, video data, audio data and application data.

37. The method of claim 27, wherein said distribution entities include at least one content provider capable of distributing the digital content or service.

38. The method of claim 27, wherein said distribution entities include at least one content right holder or licenser capable of licensing the digital content or service for distribution over the communication network.

39. The method of claim 27, wherein said distribution entities include at least one money collector capable of performing monetary transactions associated with distribution of the digital content or service over the communication network.

40. The method of claim 39, wherein said at least one money collector is capable of collecting funds from end user of the digital content or service and/or transfer money to said distribution entities.

41. The method of claim 40, wherein said funds are provided via credit or debit card debiting, electronic money or bank transfers.

42. The method of claim 27, wherein said distribution entities include at least one insurance agent capable of insuring said distribution syndicate against distribution failures.

43. The method of claim 27, wherein said request for distribution of the digital content or service is provided by an end user of the digital content or service.

44. The method of claim 27, wherein said request for distribution of the digital content or service is provided by a provider of the digital content or service.

45. The method of claim 27, wherein step (a)-(c) are effected by a central management unit capable of communicating with said distribution entities.

46. The method of claim 27, wherein step (a)-(d) are effected by at least one of said distribution entities.

47. The method of claim 27, wherein the digital service includes computational services, coordination of an off-line service, hosting an on-line game or data storage.

48. The method of claim 47, wherein the digital service is applied to a client selected from the group consisting of a software client, a firmware client, a hardware client and a terminal client

49. The method of claim 47, wherein the digital service is effected by sharing data, sharing resources, or sharing computing resources.

50. The method of claim 27, wherein the communication network is a computer network.

51. The method of claim 27, wherein the communication network is a cellular network.

52. The method of claim 27, wherein said distribution entities include at least one entity selected from the group consisting of a bandwidth provider, a service provider, an advertiser, an advertisement provider a content or services reseller, financial service provider and a security service provider.

53. The method of claim 52, wherein said security service provider is capable of providing at least one service selected from the group consisting of watermarking, data encryption, authentication, geo-location, certification, encryption key management and digital rights management.

54. A method of generating a distribution syndicate for distributing digital content or service over a communication network, the method comprising:
(a) analyzing a request for distribution of the digital content or service;
(b) selecting a plurality of syndication candidates being capable of communicating with the communication network; and
(c) generating a policy associated with distribution of the digital content or service according to information retrieved from each of said plurality of syndication candidates;
(d) using said policy to select at least one syndicate candidate from said plurality of syndication candidates thereby forming the distribution syndicate.

55. A method of distributing digital content or services over a communication network, the method comprising:
(a) analyzing a request for distribution of the digital content or service;
(b) determining a set of services necessary to distribute the digital content or services over the communication network;
(c) formulating a distribution policy according to said set of services; and
(d) assembling a distribution syndicate of distribution entities each being capable of communicating with the communication network, said distribution entities being selected according to said distribution policy, said distribution syndicate being for distributing the digital content or service over the communication network.

56. A system for distributing digital content or services over a communication network comprising a computerized central management unit designed and configured for:
(a) analyzing a request for distribution of the digital content or service;
(b) generating a policy associated with the digital content or service; and
(c) assembling a distribution syndicate of distribution entities, said distribution entities being selected according to said policy associated with distribution of the digital content or service, said distribution syndicate being for distributing the digital content or service over the communication network.

57. The system of claim 56, wherein said computerized central management unit is further designed and configured for negotiating with a plurality of distribution entity candidates prior to assembling said distribution syndicate of distribution entities.

58. The system of claim 57, wherein each of said plurality of said distribution entity candidates and said computerized central management unit operates a processing module designed and configured for enabling said negotiations between said computerized central management unit and each of said plurality of said distribution entity candidates.

59. The system of claim 57, wherein said processing module is an artificial intelligence module.

60. The system of claim 57, wherein said negotiations are used to select said distribution entities.

61. The system of claim 56, wherein said distribution entities are selected from the group consisting of content providers, content distributors, content rights holders, resellers of the content, money collection services, investors, legal services providers, financial services providers, insurance companies, content distribution networks (CDN), network service providers, advertisers, bandwidth providers, and security providers.

62. The system of claim 56, wherein said distribution entities include at least one content server being capable of transferring digital content to an end user.

63. The system of claim 62, wherein said content server is capable of streaming the digital content to said end user.

64. The system of claim 62, wherein the digital content is interactive digital content.

65. The system of claim 62, wherein said content server is further capable of interacting said end user.

66. The system of claim 65, wherein said interacting provides said end user control over said transferring of the digital content.

67. The system of claim 66, wherein said control is effected by an action selected from the group consisting of stopping said transferring of the digital content, pausing said transferring of the digital content, changing the speed of said transferring of the digital content and selecting specific data from the digital content.

68. The system of claim 56, wherein said computerized central management unit utilizes predetermined rules to assemble said distribution syndicate.

69. The system of claim 57, wherein said computerized central management unit rewards cooperative behavior by said distribution entity candidates.

70. The system of claim 56, wherein said computerized central management utilizes a cooperative algorithm for selecting said distribution syndicate.

71. The system of claim 70, wherein said cooperative algorithm includes a decentralized management protocol

72. The system of claim 56, wherein said computerized central management utilizes distributed uniform calculation of a pre-determined algorithm for selecting said distribution syndicate.

73. A system for distributing digital content or services over a communication network comprising a computerized central management unit designed and configured for:
(a) analyzing a request for distribution of the digital content or service; and
(b) selecting distribution entity candidates being capable of inter-communicating over the communication network, wherein at least one of said distribution entity candidates is designed and configured for:
(i) generating a policy associated with the digital content or service; and
(ii) assembling a distribution syndicate of distribution entities from said distribution entity candidates according to said policy associated with distribution of the digital content or service, said distribution syndicate being for distributing the digital content or service over the communication network.

74. The system of claim 73, wherein said computerized central management unit is further designed and configured for negotiating with a plurality of distribution entity candidates prior to selecting said distribution entity candidates.

75. The system of claim 73, wherein each of said plurality of said distribution entity candidates and said computerized central management unit operates a processing module designed and configured for enabling negotiations between said computerized central management unit and each of said plurality of said distribution entity candidates.

76. The system of claim 75, wherein said processing module is an artificial intelligence module.

77. The system of claim 73, wherein said distribution entity candidates are selected from the group consisting of content providers, content distributors, content rights holders, resellers of the content, money collection services, investors, legal services providers, financial services providers, insurance companies, content distribution networks (CDN), network service providers, advertisers, bandwidth providers, and security providers.

78. A method of gathering information relating to a distribution syndicate for distributing digital content or service over a communication network, the distribution syndicate being formed ad hoc from syndication entity candidates according to a request for distribution of digital data or service, the method comprising monitoring at least some of the syndication entity candidates prior to or following assembly of the distribution syndicate and collecting data pertaining to the formation and/or operation of the distribution syndicate.

79. The method of claim 78, wherein said data includes information relating to the request for distribution of digital data or service.

80. The method of claim 78, wherein said data includes information relating to policies governing formation of the distribution syndicate.

81. The method of claim 78, wherein said data includes information relating to the efficiency and/or quality of operation of the distribution syndicate.

82. The method of claim 78, wherein said data includes information relating to operational costs of the distribution syndicate.

83. The method of claim 78, wherein said data includes information relating to security of the distribution syndicate.

84. The method of claim 78, wherein said data includes information relating to operational failures within the distribution syndicate.

85. The method of claim 78, wherein said data includes information relating to an end user of the digital content or service.

86. The method of claim 85, wherein said information relating to an end user of the digital content or service includes habits of said end user and/or preferences of said end user.

87. The method of claim 78, wherein said collecting data pertaining to the formation and/or operation of the distribution syndicate is effected by a computerized central management unit designed and configured for forming the distribution syndicate.

88. The method of claim 78, wherein said collecting data pertaining to the formation and/or operation of the distribution syndicate is effected by a participant of the distribution syndicate.

89. The method of claim 78, wherein said collecting data pertaining to the formation and/or operation of the distribution syndicate is effected by at least one of the syndication entity candidates.

90. The method of claim 78, wherein said data is providable to at least some of the syndication entity candidates.

91. The method of claim 78, wherein said data is utilized for selecting syndication entities from the syndication entity candidates.

92. The method of claim 87, wherein said data is statistically processed by said computerized central management unit.

93. The method of claim 92, wherein said statistically processed data is stored in a database.

94. The method of claim 93, wherein said database is a decentralized database.
